(19) United States
(12) Patent Application Publication
(10) Pub. No.: US 2020/0265449 A1
(43) Pub. Date: Aug. 20, 2020

(54) SYSTEMS AND METHODS FOR DATA SEGMENTATION

(71) Applicant: Capital One Services, LLC, McLean, VA (US)

(72) Inventors: Deepak Sundararaj, McLean, VA (US); Narendran Sreedharan, McLean, VA (US); Yaswanth Pedavalli, McLean, VA (US); David Schaaf, McLean, VA (US); Harika Kamineni, McLean, VA (US)

(21) Appl. No.: 16/280,617

(22) Filed: Feb. 20, 2019

(51) Int. Cl. G06Q 30/02

(52) U.S. Cl. CPC G06Q 30/0204; G06Q 30/0246; G06Q 30/0269; G06Q 30/0276

(57) ABSTRACT

A method for facilitating marketing campaign workflow is disclosed. The method includes a processor receiving a user request to create a marketing campaign. Based on the user request, the processor identifies a first segmented market population and a second segmented market population. Further, the processor outputs a first request and second request seeking information about the first and second segmented market populations, respectively. In response, the processor receives the first and second segments market populations. Using customer information associated with the first and second segmented market populations, a target population database is generated. The marketing campaign is then executed to at least a portion of the target population. After a predetermined amount of time, the results of the marketing campaign are automatically compared to a previous marketing campaign.

### FIELD

The present disclosure relates to systems and methods for restructuring data segmentation, and more particularly a user interface for facilitating segmentation of data received from disparate sources and dynamically creating specialized compilations regarding the same.

### BACKGROUND

Synthesizing data across variant sources into specialized compilations is a difficult problem in numerous fields. For example, businesses and other organizations routinely attempt to effectively communicate with large groups of customers, potential customers, and/or affiliates. In the related art, for a business or organization to send out marketing communications, a customized marketing campaign must be developed and verified. However, information about customers, potential customers, and/or affiliates is often stored in various databases both inside and outside of the organization in numerous incompatible formats. In some cases, customer information may not be readily available, may contain overlapping information, or may contain inaccurate information depending on the source from which it was acquired. Due to multiple standalone segmentations, such data issues require high overhead to maintain and establish standard governance. Further, complex data file generation requires running several scripts in a sequence while switching between multiple tools and platforms and performing manual manipulations.

Accordingly, there is a need for improved systems and methods for data segmentation. Embodiments of the present disclosure are directed to this and other considerations.

### SUMMARY

Aspects of the disclosed technology relate to systems and methods for dynamically facilitating marketing campaign workflow. Consistent with the disclosed embodiments, certain embodiments may utilize one or more target user devices, vendor devices, customer information systems, databases, web servers, data segmentation devices, user terminals, local networks, and networks. In some cases, certain systems and methods may include a user terminal receiving, via a user interface, a first request to create a marketing campaign. The first request may include data associated with an eligible population and/or one or more customer population parameters. The user interface may identify a target population based at least in part on the one or more customer population parameters. The target population may include the eligible customer population as adjusted according to the one or more customer population parameters. The system may output a second request seeking information about the eligible customer population to a customer information system. The customer information system may include a plurality of storage devices storing customer information. The system may receive customer information associated with the eligible customer population from the customer information system. The system may generate a target population database including the received customer information. Further, the system may validate the customer information within the target population database. The customer information may be outputted to a data segmentation device. In return, based at least in part on the customer information, the system may receive a first segmented market population and a second segmented market population. The system may then output a campaign file including a campaign configuration. The system may also execute the marketing campaign to at least a portion of the first and second segmented market populations.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an example system environment for data segmentation, in accordance with some embodiments of the present disclosure;

FIG. 2 is an exemplary embodiment of a user terminal, in accordance with some embodiments of the present disclosure;

FIGS. 3-5 are flowcharts of example methods for data segmentation, in accordance with some embodiments of the present disclosure;

FIGS. 6-7 illustrate example user interfaces for data segmentation useful in marketing campaign generation, in accordance with some embodiments of the present disclosure;

FIG. 8 is a timing diagram for data segmentation, according to an example embodiment of the invention; and

FIG. 9 is a block diagram of an example computer system that may implement certain aspects of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Certain disclosed embodiments are directed to improved systems and methods for data segmentation. An example system may include one or more memory devices storing instructions, and one or more processors configured to execute the instructions to perform steps of a method. Various embodiments of the present disclosure may include an improved user interface for facilitating consolidated data segmentation and creation of specialized reports for executing one or more processes. For instance, in some embodiments, the improved user interface may facilitate efficient execution of marketing campaigns by automating and centralizing market segmentation, eliminating the need for hand-offs between multiple groups within a company, increase the speed to market, permit real-time A/B testing, and/or integrated real-time reporting. As a practical example, running campaigns using the current methods and systems average nearly five hours per campaign. In contrast, campaigns using various embodiments of the present disclosure may be completed in thirty-five minutes or less. Additionally, various embodiments of the present disclosure may streamline the creation of campaigns. In the past, campaign generation ranged between a few hours and a couple of days. Using various embodiments of the present disclosure, campaign generation can often be completed in less than an hour. Further, because campaigns may be stored, reused, and/or modified, generating a campaign based on a previous campaign may provide even faster campaign generation. Moreover, various embodiments of the present disclosure may also provide more accurate targeting by reducing human error. Embodiments of the present disclosure may provide more efficient and streamlined execution of marketing campaigns due to a plurality of devices (e.g., customer information system 110, user terminal 114, web server 112, data segmentation device 120) performing functions associated with campaign generation and/or data segmentation concurrently and/or in parallel.

Various embodiments of the present disclosure can include methods for generating specialized files comprising information regarding data segmentation. For instance, in some embodiments, the systems and methods can generate market campaign configuration files. Various embodiments of the present disclosure can include systems and methods for cloning specialized reports. For example, in some embodiments, the systems and methods may generate a market campaign by cloning one or more previous campaign configuration files. Various embodiments of the present disclosure can automatically initiate market campaign testing based on a desired distributed population.

An example embodiment of the present disclosure may include a system comprising one or more processors and one or more memory devices in communication with the one or more processors. The one or more memory devices may store computer program code that, when executed by the one or more processors, causes the system to perform several steps. For instance, the system may receive a first request to create a specialized report marketing campaign from a user interface via a user terminal. The first request may include data associated with an eligible customer population and/or one or more customer population parameters. Based on the one or more customer population parameters, the system may identify a target population. The target population may include the eligible customer population adjusted according to the one or more customer population parameters. The system may output a second request seeking information about the eligible customer population to a customer information system. The customer information system may include a plurality of storage devices storing customer information. The system may receive customer information associated with the eligible customer population from the customer information system. The system may generate a target population database that includes the customer information. Further, the system may validate the customer information in the target population database. The system may also output the customer information to a data segmentation device. The system may receive a first segmented market population and a second segmented market population based at least in part on the customer information from the data segmentation device. The system may output a campaign file that includes a campaign configuration. The system may further execute the marketing campaign to at least a portion of the first segmented market population and the second segmented market population.

In some embodiments, the first request to create a marketing campaign may include data indicative of one or more vendors for facilitating the execution of the marketing campaign. The campaign configuration may be outputted in a format specific to at least one of the one or more vendors. In some embodiments, the system may be configured to receive a test request to test the campaign configuration including, for example, data associated with a test percentage of the target population and a control percentage of the target population. The system may also execute the marketing campaign to the test percentage of the target population, collect first data and second data regarding a first campaign responsiveness of the test percentage and control percentage of the target population, respectively. Further, the system may also automatically determine the first campaign responsiveness based at least in part on a comparison of the first data and second data. In some embodiments, the system may store the campaign configuration file in a campaign configuration database storing a plurality of campaign configuration files.

According to some embodiments, the one or more customer population parameters may include brand-based clusters, product-based clusters, behavior clusters, propensity predictions, collaborative filters, and/or the like. The system may generate a workflow file and/or a quality control report. The customer information may include customer contact information, data representative of campaign responsiveness to marketing campaigns, customer account information, and/or the like. In some embodiments, the system may receive a selection of a previous marketing campaign, extract a campaign configuration template from the previous marketing campaign, and derive the target population from the campaign configuration template.

Another example embodiment of the present disclosure may include a system for facilitating marketing campaign workflow. The system may receive a request to create a marketing campaign. The request may include data associated with an eligible customer population and/or one or more customer population parameters. In some embodiments, the one or more customer population parameters includes brand-based clusters, product-based clusters, behavior clusters, propensity predictions, collaborative filters, and/or the like. The system may access a campaign configuration database that stores one or more campaign configuration files received from one or more previously-executed campaigns. The system may identify a first campaign configuration file based at least in part on the data in the request. The first campaign configuration file may include a target population. In some embodiments, the system may store the first campaign configuration file in a campaign configuration database. The campaign configuration database may store a plurality of campaign configuration files. The system may extract a campaign configuration template from one or more of the plurality of previously-executed campaigns. From the campaign configuration template, the system may derive the target population. The campaign configuration template may be updated based at least in part on the one or more customer population parameters. Updating the campaign configuration template may include an update to the target population. The system may generate a target population database. The target population database may include customer information about the updated target population. According to some embodiments, the customer information may include customer contact information, data representative of campaign responsiveness to marketing campaigns, customer account information, and/or the like. The system may further validate the customer information in the target population database. The system may output a second campaign configuration file that includes a second campaign configuration. Further, the system may execute the marketing campaign to at least a portion of the updated target population.

In some embodiments, the system may generate a workflow file and/or a quality control report. According to some embodiments, the request may include data associated with one or more vendors for facilitating execution of the marketing campaign. In some embodiments, the system may receive a test request to test the second campaign configuration. The test request may include data associated with a test percentage of the updated target population and a control percentage of the target population. The system may execute the marketing campaign to the test percentage of the target population. The system may also collect first data and second data regarding a first campaign responsiveness associated with the test percentage of the target population and a second campaign responsiveness associated with the control percentage of the target population, respectively. Further, the system may automatically determine campaign responsiveness based at least in part on a comparison of the first data and the second data.

Another example embodiment may include a method for facilitating marketing campaign workflow. The method may include a processor to receive a request to create a marketing campaign. The request may include data associated with an eligible customer population and one or more customer population parameters. Based on the one or more customer population parameters, the processor may identify a first segmented market population of the eligible customer population and a second segmented market population of the eligible customer population. The method may further include outputting a first request seeking customer information associated with the first segmented market population and a second request seeking customer information associated with the second segmented market population to one or more storage devices storing customer information. The processor may receive the first and second segmented market populations from the one or more storage devices. Next, the processor may generate a target population database. The target population database may include customer information associated with the first segmented market population and/or the second segmented market population. The method may then execute the marketing campaign to at least a portion of a target population. The method may also include automatically comparing, after a predetermined amount of time, one or more results obtained from the marketing campaign against one or more results obtained from a previous marketing campaign to the at least a portion of the target population.

In some embodiments, the method may further include outputting a first campaign file that includes a first campaign configuration and storing the first campaign configuration in a campaign configuration database. According to some embodiments, the method may also include receiving, as part of the request, data associated with one or more vendors for facilitating execution of the marketing campaign and executing the marketing campaign in one or more formats. Each of the one or more formats may be specific to at least one of the one or more vendors. In some embodiments, the received one or more customer population parameters may include brand-based clusters, product-based clusters, behavior clusters, propensity predictions, collaborative filters, and/or the like. In some embodiments, the received customer information may include customer contact information, data associated with campaign responsiveness to marketing campaigns, customer account information, and/or the like.

Although the above embodiments are described with respect to systems and methods, it is contemplated that embodiments with identical or substantially similar features may alternatively be implemented as non-transitory computer-readable media. Additionally, while the embodiments and example embodiments described throughout this disclosure may reference marketing campaigns, it is understood that the herein-described improved systems and methods for data segmentation can be used in various other settings including analytics and data operations.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

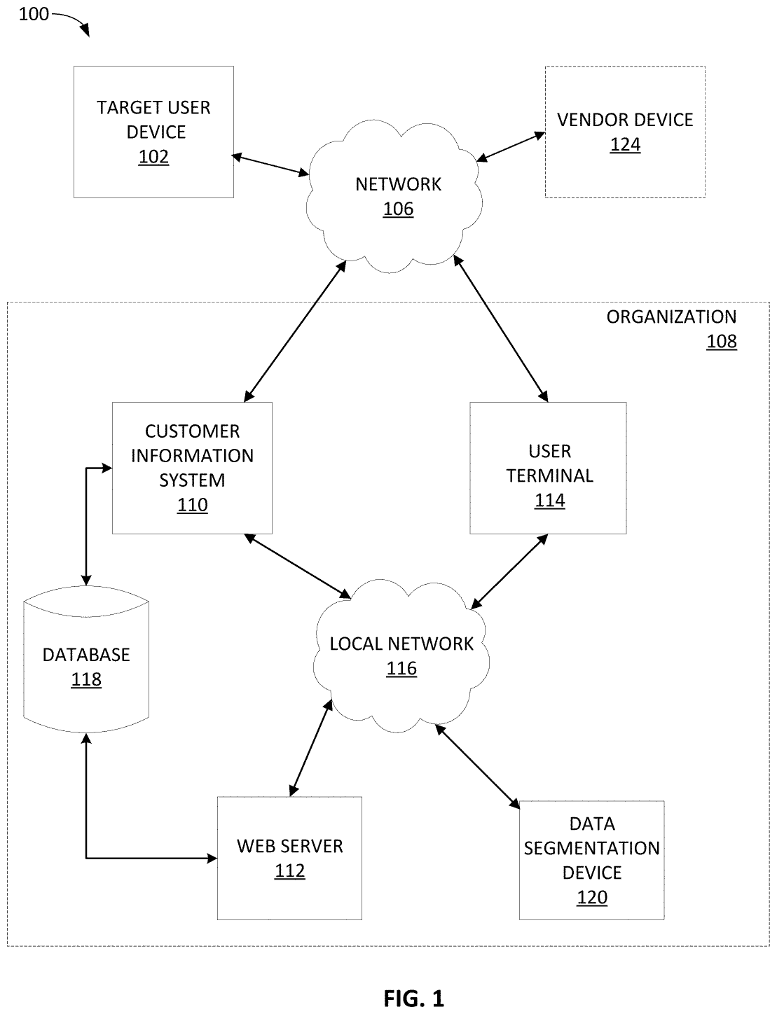

FIG. 1 is a diagram of an example system environment 100 that may be configured to perform one or more processes that may provide consolidated data segmentation and generation of specialized reports. The components and arrangements shown in FIG. 1 are not intended to limit the disclosed embodiments as the components used to implement the disclosed processes and features may vary. As shown, system 100 may include a target user device 102, a network 106, a vendor device 124, and an organization 108 including, for example, a customer information system 110, a web server 112, a user terminal 114, a local network 116, a database 118, and a data segmentation device 120.

In some embodiments, a customer may use a target user device 102. Target user device 102 may be operable to receive communications from organization 108. For instance, in some embodiments, target user device 102 may be operable to receive marketing communications from organization 108. As non-limiting examples, target user device 102 can include one or more of a mobile device, a smart phone, a general-purpose computer, a tablet computer, a laptop computer, a telephone, a PSTN landline, a smart wearable device, a voice command device, other mobile computing devices, or any other device capable of communicating with network 106 and ultimately communicating with one or more components of organization 108. Target user device 102 may belong to or be provided by a customer or may be borrowed, rented, or shared. Customers may include individuals such as, for example, subscribers, clients, prospective clients, or customers of an entity associated with organization 108, such as individuals who have obtained, will obtain, or may obtain a product, service, or consultation from an entity associated with organization 108. According to some embodiments, target user device 102 may include an environmental sensor for obtaining audio and/or visual data, such as a microphone and/or digital camera, a geographic location sensor for determining the location of the device, an input/output device such as a transceiver for sending and receiving data, a display for displaying digital images, one or more processors including a sentiment depiction processor, and a memory in communication with the one or more processors.

In some embodiments where the system is used to facilitate execution of a marketing campaign, system 100 may include vendor device 124. For instance, vendor device 124 may be associated with a third-party vendor providing one or more communication channels by which a marketing campaign may be executed. For example, in some embodiments, the vendor may be a telemarketing company, an email host, a postal service, a merchant, or a web host. According to some embodiments, system 100 will provide a generalized set of data elements via a text file (e.g., comma-separated value (CSV), fixed width, or JavaScript Object Notation (JSON)). The text file may include information such as the customer's first name, last name, email address, and/or the like. Vendor device 124 may take information from the text file and transform it into an appropriate medium to be sent to the customer. Further, the format provided to vendor device 124 would be implemented as a schema within system 100 to facilitate the customization required.

Network 106 may be of any suitable type, including individual connections via the internet such as cellular or WiFi™ networks. In some embodiments, network 106 may connect terminals, services, and mobile devices using direct connections such as radio-frequency identification (RFID), near-field communication (NFC), Bluetooth™, low-energy Bluetooth™ (BLE), ZigBee™, ambient backscatter communications (ABC) protocols, USB, WAN, or LAN. Because the information transmitted may be personal or confidential, security concerns may dictate that one or more of these types of connections be encrypted or otherwise secured. In some embodiments, however, the information being transmitted may be less personal, and therefore the network connections may be selected for convenience over security.

Network 106 may comprise any type of computer networking arrangement used to exchange data. For example, network 106 may be the Internet, a private data network, a virtual private network using a public network, and/or other suitable connection(s) that enables components in system 100 to send and receive information between the components of system 100. Network 106 may also include a public switched telephone network (“PSTN”) and/or a wireless network.

Organization 108 may be associated with an entity such as a business, corporation, individual, partnership, or any other entity that provides one or more of goods, services, and consultations to individuals such as customers. Organization 108 may employ a plurality of employees performing a variety of roles in the organization. Of those employees, organization 108 may employ a variety of experts in various areas of expertise who either gathered the requisite knowledge from experience within organization 108 or from outside organization 108.

Organization 108 may include one or more servers, devices, and computer systems for performing one or more functions associated with products and/or services that organization 108 provides. Such servers, devices, and computer systems may include, for example, customer information system 110, web server 112, user terminal 114, local network 116, database 118, and data segmentation device 120, as well as any other computer systems necessary to accomplish tasks associated with organization 108 or the needs of customers, potential customers, or affiliates.

Customer information system 110 may include a computer system configured to generate and store customer information and access (e.g., retrieve, update, and add to) various components within organization 108 via local network 116. In some embodiments, customer information system 110 may store customer information and send customer information to user terminal 114 and/or data segmentation device 120, for instance, when user terminal 114 and/or data segmentation device 120 are generating a target population database and/or a specialized report. The customer information may comprise any information acquired, received, updated, or otherwise generated by organization 108 about its customers, potential customers, or affiliates. Customer information may include an indication of campaign responsiveness, e.g., a responsiveness score generated based on a person's responsiveness to communications from organization 108. Customer information may also include information about the number of communications sent to a customer, whether the customer enrolled in a service or bought a product in response to the communication (e.g., by following links to enroll in the service), whether the customer inquired about the subject of a communication, whether the customer responded or did not respond to the communication, whether the customer explicitly declined products or services offered by a communication, customer online activity (e.g., whether the customer has recently performed searches for the information), external vendor information (e.g., whether the customer has filled out a form requesting loan information from companies), internal vendor information (e.g., whether the customer used other products of an organization), customer enrollment to a do not call list, customer email and/or mail details, or even credit information. Further, the customer information collected by organization 108 may be industry specific and/or governed by government regulations.

In some embodiments, customer information system 110 may include one or more servers, memory devices, or other computer systems storing transaction history or transaction patterns. For instance, the transaction history may include data on the types of purchases made by a customer, the number of purchases made in a given period of time, the type of payment medium by which a purchase was made (e.g., via credit card versus debit card), the amount spent in a given time, or the amount deposited into an account. For example, if a person frequently travels, the transaction history may reflect a number of airplane or hotel purchases or an amount spent per month on airplane or hotel tickets.

In some embodiments, customer information system 110 may include one or more servers, memory devices, or other computer systems storing personal information of customers or potential customers. For instance, the personal information may include contact information, an address, social security numbers, driver's license numbers, birthdate, age, social media information, and/or biometric data (e.g., fingerprint information, retina scan information, facial recognition data, voice recognition data).

In some embodiments, customer information system 110 may store account-holder information. For instance, account-holder information may include as products or services in which the person is enrolled (e.g., loans, mortgages, credit loans, credit/debit cards, accounts), and the person's credit score, credit/debit card numbers, checking account numbers, and account balances.

In some embodiments, customer information system 110 may include one or more servers, memory devices, or other computer systems configured to acquire and store social media information. For instance, social media information may include social media posts, location information acquired from a social media account, or a social media user name. The social media information may be acquired directly by customer information system 110 by accessing one or more social media systems, or the social media information may be acquired by a third-party data mining service.

In some embodiments, customer information may include an indication of campaign responsiveness, e.g., a responsiveness score generated based on a person's responsiveness to communications from organization 108. For example, organization 108 may use the following as factors: the number of communications sent to an individual customer, the number of communications opened by the customer, and whether the customer clicked an interactive link and the result of the click for each opened communication (e.g., whether the customer made a purchase). Each factor, with the exception of the number of communications sent, may be assigned a value. For example, each communication opened may have a value of five, each clicked interactive link may have a value of ten, and each resulting purchase may have a value of twenty. Each factor is tallied and then divided by the number of communications sent to a customer. The result is determined to be the individual customer's responsiveness score.

According to some embodiments, the responsiveness score may be based on customer phone calls and/or emails to a customer service or support center inquiring about the product or service advertised in a campaign. In this scenario, an inquiry (e.g., a call) may have a lower value than a resulting purchase. In some examples, the responsiveness score may be generated by adding the inquiry value to the purchase value and dividing the result by the number of campaigns sent to the customer.

User terminal 114 may include a computer system configured to access a marketing campaign interface and generate campaign configurations. As described in further detail below, user terminal 114 may include one or more computing devices that are configured to generate campaign configurations. User terminal 114 may access via local network 116 one or more devices (e.g., web server 112, database 118, customer information system 110, and data segmentation device 120) of system 100 to provide a user of user terminal 114 with information or otherwise allow the user to initiate data segmentation or generate specialty reports via user terminal 114.

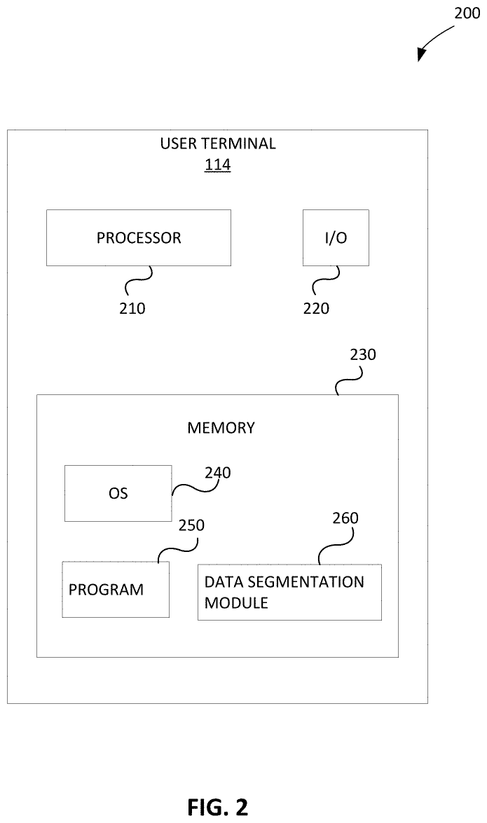

According to some embodiments, user terminal 114 may be in communication with or store a data segmentation module. In some embodiments, the data segmentation module may be accessible via data segmentation device 120 or stored on a memory of user terminal 114 (as discussed in greater detail with reference to FIG. 2).

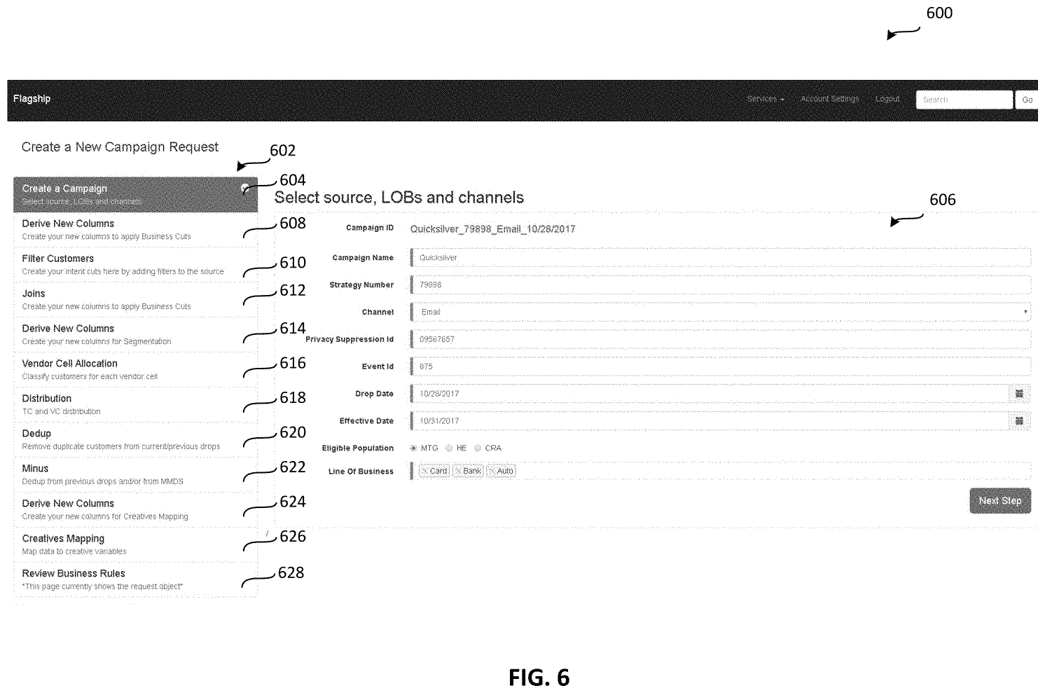

The data segmentation module may comprise a user interface for facilitating data segmentation and generation of specialty reports by a user of user terminal 114. For instance, the user interface may allow for the creation of a marketing campaign (as discussed in greater detail with reference to FIG. 6). User terminal 114 may display the user interface to the user and receive a request to create a marketing campaign. In some embodiments, the request to create a marketing campaign may include one or more user inputs comprising a campaign name, an effective date, customer population parameters (e.g., a line of business), geographic location, metadata, and an eligible population.

In some embodiments, a user may specify a base population. As used herein, a base population may refer to a group or sub-group to which customer population parameters are applied. For instance, in some embodiments, a base population may be all customers with a mortgage through the organization 108, all customers with a credit card through the organization, or all customers with an auto loan through the organization. As in the preceding example, when a user specifies a base population, a set of algorithms may determine a baseline eligible population and steps constructed from encapsulated, decoupled blocks may be used to reorder and execute across multiple steps as needed for any specific campaign. For example, a specific group may be selected based on previously entered customer population parameters. Customer population parameters entered via user terminal 114 may then be applied as fields within an algorithm identifying a sub-group from amongst the previously identified base population. Accordingly, this aids the user (e.g., campaign developer) in formulating the steps needed to streamline the data extraction and transformation process in a standardized and well-managed way.

A user may specify one or more customer population parameters via a user interface. The user interface may be a graphical user interface (GUI) allowing the user to enter information into one or more fields of the GUI. As used herein, customer population parameters may refer to one or more exclusionary rules applied to the base population. For instance, the one or more exclusionary rules may include minors, customers already enrolled in the same or similar product or service as the target marketing campaign, and/or customers enrolled in a specific type of product (e.g., bank card, credit card, auto loan, or mortgage) or service. The customer population parameters may be explicit (e.g., exclude all customers over 60) or determinable (e.g., exclude customers who are likely to self-insure).

According to some embodiments, segmentation may be performed based on statistical clustering (e.g., brand-based clustering, product-based clustering, and behavioral clustering) of the population. Clustering may refer algorithmically segmenting target groups by “closeness” based on numerous variables. For instance, a brand-based cluster may segment customers based on prior purchases of products or services affiliated with a particular brand. Similarly, product-based clusters may segment customers based on a prior purchase of a particular product or service, while behavior clusters may segment customers based on consumer purchase behavior that may be influenced by purchase trends, geographic similarities, demographic similarities, or psychographic similarities.

User terminal 114, through the user interface, may consider customer propensity predictions when identifying a target population. Propensity predictions may be calculations determined using predictive analytical tools (e.g., data, statistical algorithms, and/or machine learning techniques) of the likelihood of a customer to purchase a product or service. For instance, a propensity prediction may give “true” predictions about customer behavior. In some embodiments, propensity models may include a predictive lifetime value, a likelihood of engagement, a propensity to unsubscribe, a propensity to convert, a propensity to buy, or a propensity to churn (e.g., likelihood of an individual to purchase a product and/or service for only a limited time).

In some embodiments, user terminal 114, through the user interface, may consider collaborative filtering when identifying a target population. Collaborative filtering may refer to predictive models which are used for recommending products, services, and advertisements to customers based on a variety of variables, including past buying behaviors. In some embodiments, collaborative filtering may include up-sell models, cross-sell models, and next-sell recommendations.

According to some embodiments, a user may specify an eligible population. As used herein, an eligible population may be the base population minus the excluded population (e.g., those excluded via the one or more customer population parameters). In some embodiments, user terminal 114 may be configured to communicate with customer information system 110 and/or database 118 to identify the eligible customer population. For instance, user terminal 114 may send data indicative of the base population and the one or more customer population parameters to customer information system 110 as part of a query request and receive data indicative of the eligible customer population back from customer information system 110 and associated information (as discussed in greater detail above). In some embodiments, user terminal 114 may be configured to communicate with data segmentation device 120 to identify a plurality of segmented market populations. As used herein, a segmented market population may include small pools of relatively similar customers. For instance, customer similarity may be ascertained based on customer transaction history, customer enrollment in one or more services or purchase of one or more products, customer spending patterns based on the information acquired by the customer information system 110, and/or customer population parameters including brand-based clusters, product-based clusters, behavior clusters, propensity predictions, and collaborative filters. In some embodiments, segmented market populations may also be defined based on the base population and the one or more customer population parameters.

Further, a user may specify a test distribution of the eligible population to test the effectiveness of a communication. The test distribution may include a test percentage of the eligible population to which the communication is sent and a control percentage of the eligible population who are monitored over a period of time and server as a control to determine how effective the communication was. For instance, the test distribution may assist with determining campaign responsiveness.

In some embodiments, a user may specify a campaign channel. As used herein, a campaign channel may be a channel through which the campaign is to-be executed. For instance, the campaign channel may include email, telephone, mail, or text.

User terminal 114 may output a specialty report, such as a campaign configuration file. User terminal 114 may send the specialty report to database 118 for storage therein. In some embodiments, the specialty report may comprise information regarding the target population including the base population, customer population parameters, types of segmentation performed, vendor, execution strategy, and metadata. In some embodiments, a specialty report may be a JavaScript Object Notation (JSON) formatted file. User terminal 114 may be configured to output a workflow file and a quality control report. In some embodiments, the workflow file can permit automated or repeated execution of tasks involved in the providing the communication to the segmented population. For example, to repeat an annual campaign, the user may choose to reuse an existing configuration file. Details about the file are inputted by the user and retrieved from database 118 to generate a new instance of the campaign. Additionally, the user may update or change details of the campaign to customize the campaign. Further, the new instance of the campaign may be saved to database 118 for future use. As a result, it is significantly easier for users to repeat campaigns when compared to having to recreate the campaigns each time. In some embodiments, the quality control report may include information about the workflow such as the steps required to execute the campaign, the campaign name, the campaign date, and other details of the campaign.

Web server 112 may include a computer system configured to provide a user interface to user terminal 114. As described in further detail below, web server 112 may include one or more computing devices that are configured to provide a user interface to user terminal 114. Information stored on web server 112 may be accessed (e.g., retrieved, updated, and added to) via local network 116 by one or more devices (e.g., database 118, customer information system 110, data segmentation device 120, or user terminal 114) of system 100.

Data segmentation device 120 may include a computer system configured to perform data segmentation and execute communications based on the segmented population. In some embodiments, data segmentation is initiated by a user via user terminal 114 based on user selected customer population parameters. Data segmentation device 120 may receive data from user terminal 114, database 118, and/or customer information system 110. Data segmentation device 120 may segment the received data based on one or more exclusionary rules (e.g., customer population parameters). Data segmentation device 120 may include one or more computing devices that are configured to perform data segmentation and execute communications. Data segmentation device 120 may also receive information via local network 116 and/or network 106 from one or more devices (e.g., web server 112, database 118, and customer information system 110) of system 100.

Local network 116 may comprise any type of computer networking arrangement used to exchange data in a localized area, such as WiFi, Bluetooth™ Ethernet, and other suitable network connections that enable components of organization 108 to interact with one another and to connect to network 106 for interacting with components in system 100. In some embodiments, local network 116 may comprise an interface for communicating with or linking to network 106. In other embodiments, components of organization 108 may communicate via network 106, without a separate local network 116.

According to some embodiments, database 118 may be a database associated with organization 108 that stores a variety of information relating to customers, transactions, and business operations. Database 118 may also serve as a back-up storage device and may contain data and information that is also stored on, for example, local databases associated with customer information system 110, web server 112, user terminal 114, and data segmentation device 120. For instance, in some embodiments, database 118 may be accessed by user terminal 114 and customer information system 110 and may be used to store specialty reports (e.g., campaigns previously executed) and customer information.

Although the preceding description describes various functions of customer information system 110, web server 112, user terminal 114, database 118, and data segmentation device 120, in some embodiments, some or all of these functions may be carried out by a single computing device.

The steps or processes disclosed herein are not limited to being performed in the order described but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments, or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

An exemplary embodiment of user terminal 114 is shown in more detail in FIG. 2. Target user device 102, vendor device 124, customer information system 110, web server 112, and data segmentation device 120 may have a similar structure and may include many components that are similar to or even have the same capabilities as those described with respect to user terminal 114. As shown, user terminal 114 may include a processor 210, an input/output (“I/O”) device 220, a memory 230 containing an operating system (“OS”) 240, a program 250, and a data segmentation module 260. For example, user terminal 114 may be a single device or server or may be configured as a distributed computer system including multiple servers, devices, or computers that interoperate to perform one or more of the processes and functionalities associated with the disclosed embodiments. In some embodiments, user terminal 114 may further include a peripheral interface, a transceiver, a mobile network interface in communication with the processor 210, a bus configured to facilitate communication between the various components of user terminal 114, and a power source configured to power one or more components of user terminal 114.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of radio-frequency identification (RFID), near-field communication (NFC), Bluetooth™, low-energy Bluetooth™ (BLE), WiFi™, ZigBee™, ambient backscatter communications (ABC) protocols or similar technologies.

FIG. 2 is an exemplary embodiment of a user terminal 114 that may perform one or more processes providing consolidated data segmentation and/or generation of specialized reports A mobile network interface may provide access to a cellular network, the Internet, a local area network, or another wide-area network. In some embodiments, a mobile network interface may include hardware, firmware, and/or software that allows the processor(s) 210 to communicate with other devices via wired or wireless networks, whether the local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read-only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

User terminal 114 may include one or more storage devices configured to store information used by processor 210 (or other components) to perform certain functions related to the disclosed embodiments. In some embodiments, user terminal 114 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In some embodiments, user terminal 114 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, user terminal 114 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 230 may include software components that, when executed by processor 210, perform one or more processes consistent with the disclosed embodiments. In some embodiments, memory 230 may include a database for storing related data to enable user terminal 114 to perform one or more of the processes and functionalities associated with the disclosed embodiments.

User terminal 114 may also be communicatively connected to one or more memory devices (e.g., databases) locally or through a network. The remote memory devices may be configured to store information and may be accessed and/or managed by User terminal 114. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

User terminal 114 may also include one or more I/O devices 220 that may comprise one or more interfaces for receiving signals or input from devices and providing signals or output to one or more devices that allow data to be received and/or transmitted by user terminal 114. For example, user terminal 114 may include interface components, which may provide interfaces to one or more input devices, such as one or more keyboards, mouse devices, touch screens, track pads, trackballs, scroll wheels, digital cameras, microphones, sensors, and the like, that enable user terminal 114 to receive data from one or more users (such as, for example, via target user device 102).

In exemplary embodiments of the disclosed technology, user terminal 114 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

User terminal 114 may also include a data segmentation module 260, as discussed above. Data segmentation module 260 may include any number of hardware and/or software applications that are executed to facilitate providing a user interface to a user, perform data segmentation, and generate one or more specialty reports. In some embodiments, data segmentation module 260 may include a web UI. In some examples, the web UI can be built using Angular 4.1 with REST services, or similar.

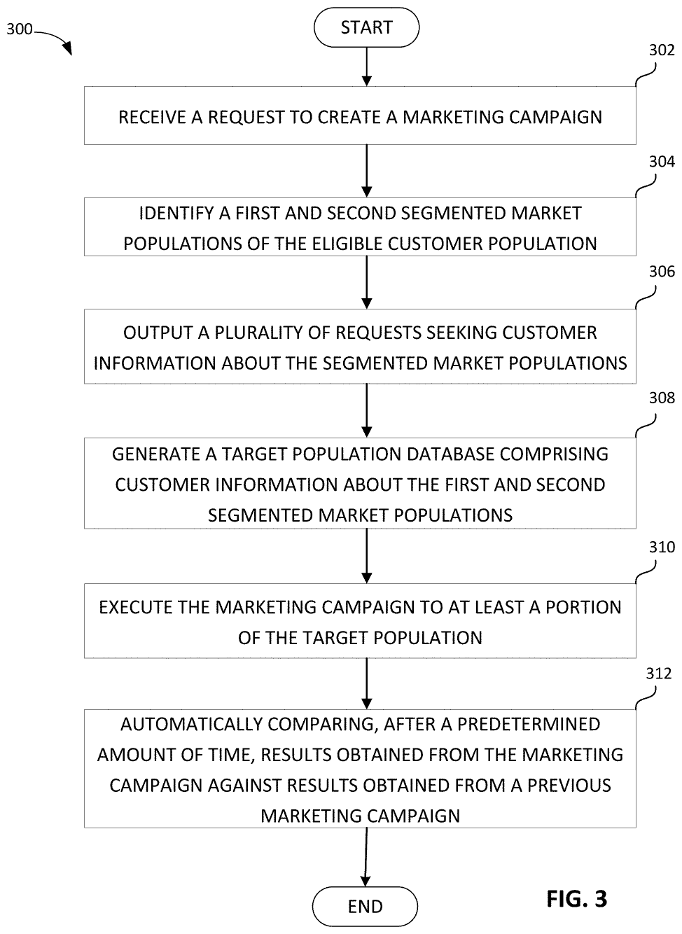

FIG. 3 illustrates an exemplary method 300 for data segmentation, performed by an organization and useful in creating marketing campaigns, in accordance with some embodiments of the present disclosure. At block 302, the method may include receiving a request to create a marketing campaign. In some embodiments, the request may be created via a user interface accessed by a user (e.g., via user terminal 114). The user request may include one or more customer population parameters (e.g., business rules) provided via a user interface of user terminal 114. The customer population parameters may help identify segmented market populations by including one or more population inclusion and/or exclusions rules. For example, the customer population parameters may exclude adults over 65 years of age from the included population.

At block 304, method 300 may identify a first and second segmented market populations of the eligible customer population. Identifying the first and second segmented market populations of the eligible customer population may be based on applying the one or more customer population parameters to the eligible customer population. In some embodiments, the method may include identifying additional segmented market populations of the eligible customer population. Segmenting the market populations into a first and second segments may allow organization 108 to tailor marketing messages to specific market population. For instance, such segmentation may include targeting different groups with messages that are more appealing to their situation. A customer can refinance her home to purchase a boat, for example, because her customer information includes intent to purchase a boat. Or, a customer can refinance her home to consolidate her credit card debt, for example, because her customer information includes an indication of significant debt. Further, such segmentation may be used to tailor terms of an offer to a specific audience. Consequently, an organization has significantly more power to create granular and personal offers, which can result in higher response rates and a better customer experience.

At block 306, method 300 may include outputting a plurality of requests seeking customer information about the first segmented market population and customer information about the second segmented market population. In some embodiments, the plurality of requests may be sent to one or more computing systems storing customer information (e.g., customer information system 110, database 118, web server 112, and/or data segmentation device 120). Customer information obtained from the plurality of requests may be included in the generated target population database.

At block 308, method 300 includes generating a target population database comprising customer information about the first and second segmented market populations. The target population database may be generated and modified depending on the user selected constraints (see, e.g., FIG. 6, “Derive New Columns” 608, “Filter Customers” 610, “Joins” 612, “Derive New Columns” 614).

At block 310, method 300 may include executing the marketing campaign to at least a portion of the target population. Executing the marketing campaign may include disseminating the contents of the marketing campaign to users identified as a portion of the target population. For example, for an email campaign channel, the identified target population will receive an email containing the marketing materials. At block 312, method 300 may comprise automatically comparing, after a predetermined amount of time, results obtained from the marketing campaign against results obtained from one or more previous marketing campaigns. The results may be used in developing future campaigns or modifying ongoing campaigns. In some embodiments, the previous marketing campaigns may be test campaigns, for example, where the marketing campaign is disseminated to a fraction of the identified population.

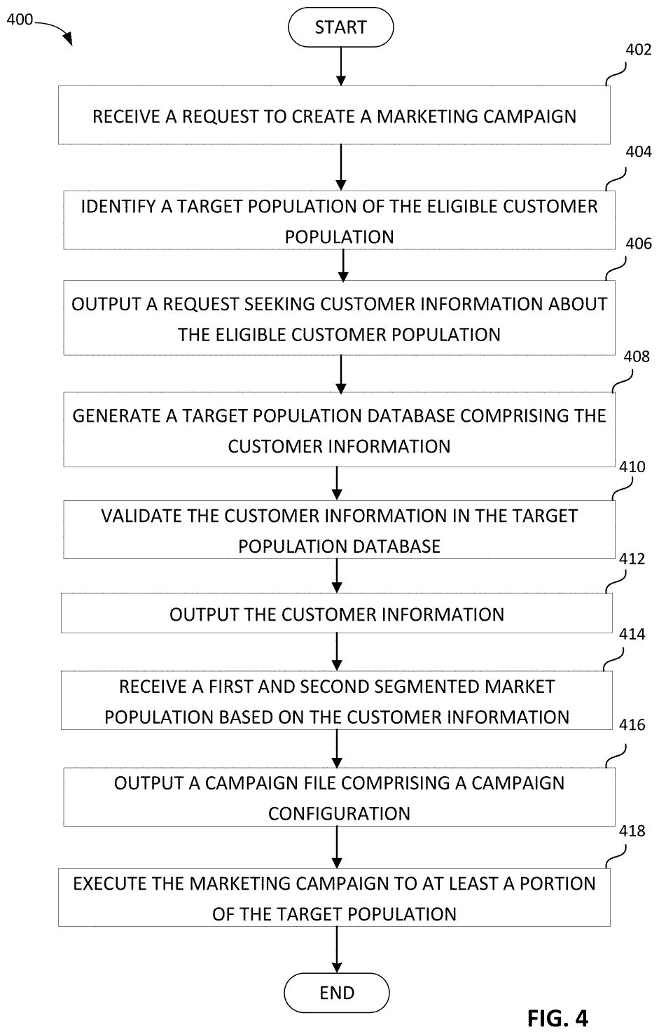

FIG. 4 illustrates another exemplary method 400 for data segmentation, performed by an organization and useful in creating marketing campaigns, in accordance with some embodiments of the present disclosure. At block 402, method 400 may include receiving a request to create a marketing campaign. In some embodiments, the request may include data indicative of an eligible population and/or one or more customer population parameters. For instance, the customer population parameters may comprise at least one from among brand-based clusters, product-based clusters, behavior clusters, propensity predictions, and collaborative filters.

In some embodiments, the request may include an indication of a selection of a previous marketing campaign. In some embodiments, the previous marketing campaign may comprise a campaign configuration file from a previously-executed campaign. The campaign configuration file may include a campaign configuration template including the target customer population. The system may extract the campaign configuration template from the previous marketing campaign, and/or derive the target customer population from the campaign configuration template. Extraction may be performed by determining data associated with the request corresponds to certain fields and/or data associated with the campaign configuration template. Once recognized, the system may parse the data from the fields and other data within the file for use in developing a new campaign.

In some embodiments, the request may further comprise data indicative of one or more vendors for facilitating execution of the marketing campaign or computer program code further configured to output the campaign configuration in a format specific to each of the one or more vendors.

At block 404, method 400 may include identifying a target population of the eligible customer population. The target population may be identified based on one or more customer population parameters. The one or more customer population parameters may help identify a target population of the eligible customer population by including one or more population inclusion and/or exclusions rules. For example, the customer population parameters may exclude children under age 14 from the included population. At block 406, method 400 may output a request seeking information about the segmented market populations. The method 400 may seek information about the eligible population from the customer information system 110, the database 118, the web server 112, and/or the data segmentation device 120. In some embodiments, the customer information may comprise at least one from among customer contact information, data representative of campaign responsiveness to marketing campaigns, and customer account information.

At block 408, method 400 may comprise generating a target population database comprising customer information about the segmented market populations. At block 410, the method 400 may include validating the customer information in the target population database. In some examples, a series of defined data quality rules and standard comparison methodology, such as statistical methods (e.g., standard deviation, min, max), may be used to validate the customer information. The validation step may process the customer information and perform required checks specified by the organization. The required checks may be included by default in a rules engine within the system that performs such validations of the data. Further, the customer information can be read into this process step, and each defined rule may be executed, standard checks can be executed on each field, and a final report can be produced showing the results of the validation.

At block 412, the method 400 may include outputting the customer information to the data segmentation device 120. In response, at block 414, the method 400 may involve receiving from the data segmentation device 120, a first and second segmented market population based on the customer information. At block 416, the method 400 may output a campaign file comprising a campaign configuration. The campaign file may contain information such as campaign name, steps to be performed, suppressions to be applied, campaign type, output required, the market populations to send the campaign, and/or the like. The information may be received as part of the request to create a marketing campaign. The information within the campaign file may be used in the process of executing the campaign on the target population. In some embodiments, the campaign configuration file may be stored in a campaign configuration database. In some embodiments, the method 400 may further comprise generating a workflow file and a quality control report. The workflow file may provide a detailed schematic of the steps required to execute the campaign and may be useful for complex execution patterns. Additionally, the system may use the workflow file to understand the approach taken, to execute the campaign, and/or to enforce best practices. The quality control report represents the implementation of the validation rules previously described and provides results back to the executor of the campaign (e.g., user) to confirm the successful use of the campaign. The executor of the campaign may use the quality control report as a manual check, for example, to confirm accuracy and to serve as an audit artifact. When the system supplements the workflow file with the quality control report, the combinations create a substantial artifact for audit and tracking purposes.

At block 418, method 400 may comprise executing the marketing campaign to at least a portion of the target population. Executing the marketing campaign may include transmitting the market campaign via one or more campaign channels (e.g., email, text, telephone) to selected customers either sequentially or in parallel.

In some embodiments, method 400 may further involve receiving a test request to test the campaign configuration. The test request may include data indicative of a test percentage of the target population and a control percentage of the target population. As a result of the test request, the marketing campaign may be executed to the test percentage of the target population. For example, the test request may involve the marketing campaign being sent to ten percent of the target population. The method may further include monitoring the responsiveness of the marketing campaign sent to the test percentage of the target population. Additionally, the method may include collecting data regarding the control percentage of the target population. Based on a comparison of the marketing campaign responsiveness of the test percentage with data collected regarding the control percentage of the target population, campaign responsiveness may be automatically determined.

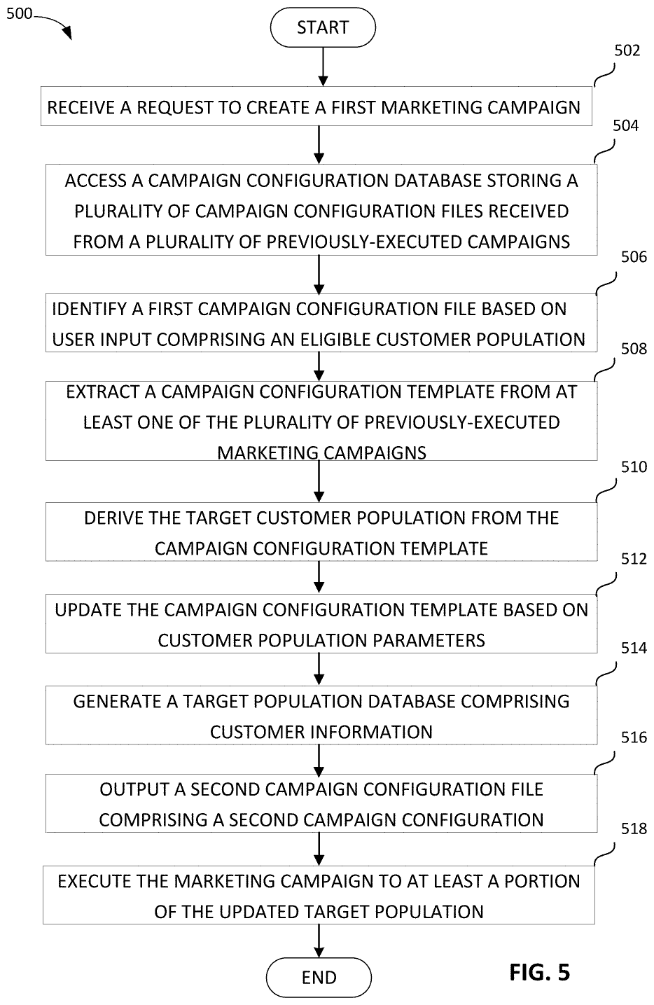

FIG. 5 illustrates an exemplary method 500 for data segmentation useful in creating marketing campaigns, in accordance with some embodiments of the present disclosure. Method 500 may have similar processes discussed above. As shown in FIGS. 3 and 4, at block 502, method 500 may include receiving a request to create a marketing campaign.

At block 504, method 500 may include accessing a campaign configuration database storing a plurality of campaign configuration files received from a plurality of previously-executed campaigns. The campaign configuration files may be stored in the customer information system 110, the database 118, the web server 112, and/or the data segmentation device 120. At block 506, method 500 may comprise identifying a campaign configuration file based on user input including an eligible customer population. The user input may include a selection of parameters. Identifying the first campaign configuration file may further include comparing the user inputted parameters to attributes of the campaign configuration files to determine a campaign configuration file most closely matching the user input. The campaign configuration file may include a target population. In some embodiments, the campaign configuration file may be stored in a campaign configuration database that stores a plurality of campaign configuration files. For example, the campaign configuration file may be stored in database 118.

At block 508, method 500 may involve extracting a campaign configuration template from one of the plurality of previously-executed marketing campaigns. The previously-executed marketing campaigns associated with the extracted campaign configuration template may also be associated with the identified campaign configuration file. At block 510, method 500 may comprise deriving the target customer population from the campaign configuration template which may include identifying, accessing, and/or extracting the target customer population portion of the campaign configuration template. At block 512, method 500 may involve updating the campaign configuration template based on customer population parameters. For instance, a user may select a customer population parameter limiting the target population to consumers with an income greater than fifty-thousand dollars. In response to the user inputted customer population parameter, the target population may be narrowed to consumers meeting the specified income. Similar to that described above with reference to blocks 308 and 408 of FIGS. 3 and 4, respectively, the method 500 may involve generating a target population database comprising customer information, at block 514.

At block 516, method 500 may involve outputting a campaign configuration file comprising a campaign configuration. At block 518, method 500 may involve executing the marketing campaign to at least a portion of the target population. Executing the marketing campaign may be substantially similar the that described above with reference to blocks 310 and 418 of FIGS. 3 and 4.

FIG. 6 illustrates an example of a user interface, in accordance with some embodiments of the present disclosure, through which the request may be created. As shown in FIG. 6, the user interface 600 can include a variety of options for creating, testing, and executing marketing campaigns, including performing market segmentation. Task list 602 may include several other tasks involved in creating a campaign. For instance, task list 602 may include a create a campaign task 604. Create a campaign task 604, when implemented, may be used to perform block 402 and/or block 502, of FIG. 4 and FIG. 5, respectively. As shown in FIG. 6, when selected, the campaign task 604 can allow a user to fill in various fields 606. When selected, create a campaign task 604 may display a plurality of fields to initiate campaign creation. These fields 606 may include a campaign name, a campaign channel, a drop date, an effective date, an eligible population, and a line of business selection (e.g., customer population parameter). The campaign channel may include the communication channel by which the campaign is to-be-sent to a person (e.g., email, mail, telephone, etc.). In some embodiments, the eligible population may include a population of account-holders that may be targeted. For instance, this may include account-holders having a mortgage with an organization. In some embodiments, the one or more business rules (i.e. “line of business”) may include an auto-populate function based on business rules stored in association with the user interface.

Task list 602 may include various options to create a target population database based on market segmentation (e.g., “Derive New Columns” 608, “Filter Customers,” 610, “Joins” 612, “Derive New Columns for Segmentation” 614). Task list 602 may include a “Vendor Cell Allocation” 616 task for a specific segmentation to retrieve or generate a specific message to be sent to a customer, a “Distribution” 618 task for creating and testing a test population, a “Dedup” 620 task and a “Minus” 622 task to deduplicate the segmented database to remove duplicated entries, a “Derive New Columns” 624 task for creating new columns for creative mapping, a “Creatives Mapping” 626 task for providing a pathway to identify which of the creative mappings should be sent and provided to which customer, and a “Review Business Rules” 628 task for reviewing the draft campaign configuration.

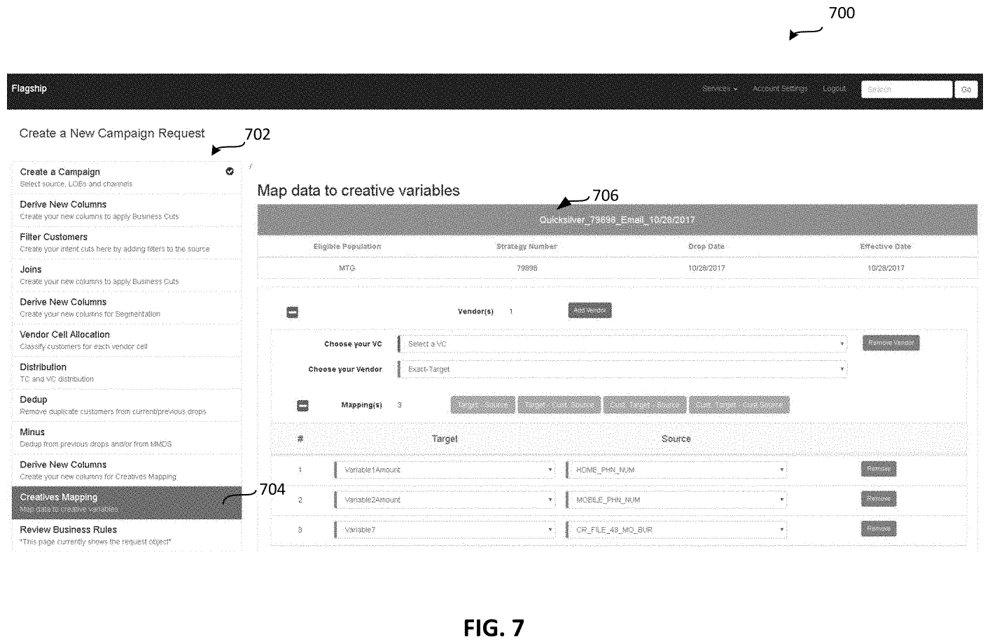

FIG. 7 illustrates an exemplary user interface 700 including a page for mapping data to creative variables, in accordance with some embodiments of the present disclosure. Task 702 includes various tasks including a “Creatives Mapping” 704 task. As illustrated in FIG. 7, when “Creatives Mapping” 704 task is selected, a plurality of fields 706 to map data to creative variables may be displayed including choosing a vendor and a vendor context “VC.” Creatives mapping 704 can also include choosing various targets and sources from predefined dropdown box options. Because target and source variable names may differ between an organization and a vendor, this enables a mapping from one variable the organization defined to another the vendor requires as input. Each creative mapping selection (e.g., Creatives Mapping 704) may have a unique set of variables that need to be populated. Therefore, the system requires the flexibility to accept a number of unique variables. For example, one creative might require a first name, a last name, an address, and an offer amount, while another creative mapping selection might include the listed variables, an interest rate, and a loan term. This flexibility enables complete control over populating this information on a creative mapping selection no matter how granular the segment.

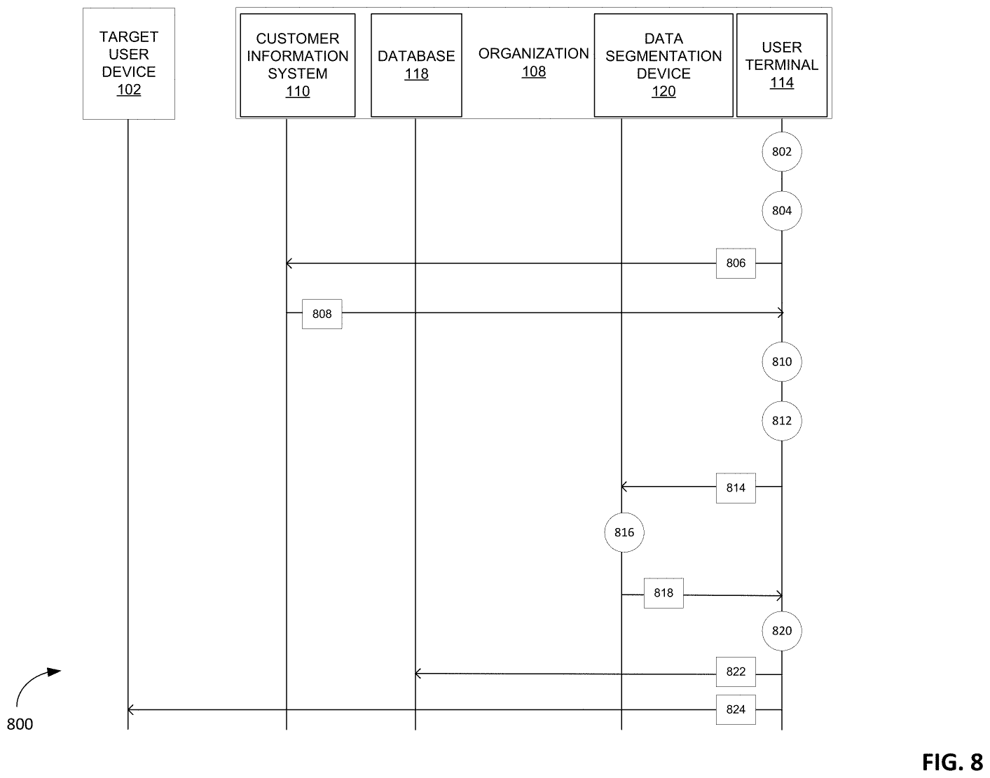

FIG. 8 is a timing diagram 800 for data segmentation, in accordance with an example embodiment of the present disclosure. According to some embodiments, at 802, the user terminal 114 receives a request to create a marketing campaign, e.g., via a user input in a user interface as presented in FIG. 6 and/or FIG. 7. The user request may be created via a user interface accessed by a user. The request may include data indicative of an eligible population and/or one more customer population parameters (e.g., business rules). The customer population parameters may help identify segmented market populations by including one or more population inclusion and/or exclusions rules. At 804, user terminal 114 identifies a target customer population. Identifying the target customer population may involve adjusting the eligible population based on the customer population parameters. For example, the eligible population may be adjusted to include only customers making over a certain income.

At 806, user terminal 114 outputs a request to customer information system 110 for information about the eligible customer population. In response, at 808, customer information system 110 outputs customer information about the eligible customer population to data segmentation device 120. At 810, user terminal 114 generates a target population database. The target population database may include the customer information. At 812, user terminal 114 may validate the customer information in the target population database. Validating the customer information may include comparing the customer information to the user provided customer population parameters for at least a portion of a match. At 814, user terminal 114 may output the customer information to data segmentation device 120. Data segmentation device 120 may segment the customer information into a first and second segmented market population, at 816. At 818, data segmentation device 120 outputs the first and second segmented market populations to user terminal 114. At 820, user terminal 114 generates a campaign file, i.e., user terminal 114 accepts input(s) from the user that are used by the system to create the campaign file. The campaign file may include a campaign configuration template. At 822, user terminal 114 outputs the campaign file for storage at database 118. The stored campaign file may later be retrieved for use in future marketing campaigns. At 824, user terminal 114 executes the marketing campaign to target user device 102. For example, user terminal 114 may send the marketing campaign to target user 120 as an email marketing campaign.

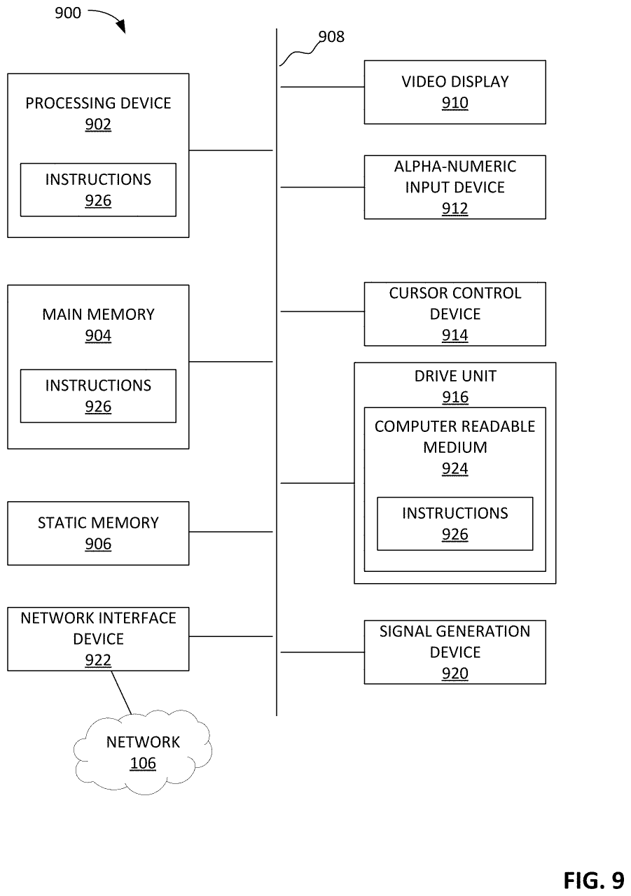

FIG. 9 is a block diagram of an example computer system 900 that may implement certain aspects of the present disclosure. In some embodiments, computer system 900 may be associated with user terminal 114. The computer system 900 may include a set of instructions 926 for controlling operation of the computer system 900. In some implementations, the computer system 900 may be connected (e.g., networked) to other machines in a Local Area Network (LAN), an intranet, an extranet, a satellite communications system, or the Internet. For example, computer system 900 may be connected to customer information system 110, database 118, web server 112, data segmentation device 120, and/or user terminal 114. The computer system 900 may operate in the capacity of a server or a client machine in a client-server network environment, or as a peer machine in a peer-to-peer (or distributed) network environment. As non-limiting examples, the computer system 900 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single computer system 900 is illustrated, the term “machine” shall also be taken to include any collection of machines (e.g., computers) that individually or jointly execute a set (or multiple sets) of instructions to perform any one or more of the methodologies discussed herein.

The computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a secondary memory 916 (e.g., a data storage device), which communicate with each other via a bus 908.

The processing device 902 represents one or more general-purpose processing devices such as a microprocessor, a microcontroller, a central processing unit, or the like. As non-limiting examples, the processing device 902 may be a reduced instruction set computing (RISC) microcontroller, a complex instruction set computing (CISC) microprocessor, a RISC microprocessor, very long instruction word (VLIW) microprocessor, a processor implementing other instruction sets, or one or more processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute the operations for electronically creating and trading derivative products based on one or more indices relating to volatility.

The computer system 900 may further include a network interface device 922, which is connectable to a network 106. The computer system 900 also may include a video display unit 910, i.e., a display (e.g., a liquid crystal display (LCD), a touch screen, or a cathode ray tube (CRT)), an alphanumeric input device 912 (e.g., a keyboard), a cursor control device 914 (e.g., a mouse), and a signal generation device 920 (e.g., a speaker).

The secondary memory 916 may include a non-transitory storage medium 924 on which is stored one or more sets of instructions 926 for the computer system 900 representing any one or more of the methodologies or functions described herein. For example, the instructions 926 may include instructions for implementing an asset tracking device including a power source and power management system or subsystem for a container or a trailer. The instructions 926 for the computer system 900 may also reside, completely or at least partially, within the main memory 904 and/or within the processing device 902 during execution thereof by the computer system 900, the main memory 904 and the processing device 902 also constituting computer-readable storage media.

While the storage medium 924 is shown in an example to be a single medium, the term “storage medium” should be taken to include a single medium or multiple media that store the one or more sets of instructions for a processing device. The term “storage medium” shall also be taken to include any medium that is capable of storing or encoding a set of instructions for execution by the machine that cause the machine to perform any one or more of the methodologies of the disclosure. The term “storage medium” shall accordingly be taken to include, but not be limited to, solid-state memories, and optical and magnetic media.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution, and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include but are not limited to portable computers, tablet PCs, internet tablets, PDAs, ultra-mobile PCs (UMPCs), wearable devices, and smart phones. Additionally, implementations of the disclosed technology can be utilized with the internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Case

The following exemplary use cases describe examples example implementations of a typical user flow pattern. These examples are intended solely for explanatory purposes and not limitation. In one case, a user (e.g., a marketing associate or a data analyst) accesses a user interface (e.g., the user interface of FIGS. 6 and 7) from his work computer (e.g., user terminal 114). The user selects an option to create a new marketing campaign and identifies, through the user interface, a target population and parameters (e.g., exclusions) to which the user would like to send the marketing campaign. For example, the user names the campaign selects an eligible population and chooses a line of business (e.g., banking). In the background, the user interface may request customer information about a customer population from a data store storing a variety of information about various customers having an account with an organization (e.g., customer information system 110). After receiving the requested customer information, the user generates a target population database via the user's inputs provided via the user interface. The user, via his work computer, selects an option to validate the information in the generated target population database. Next, the user selects an option for further customer information from a second data store storing customer information (e.g., data segmentation device 120). In response, the user receives segmented market populations used to generate a campaign file. The user selects an option to store the retrieved information as a campaign file within a database (e.g., database 118) of the organization. Then, using the campaign file, the marketing campaign is sent, via email, to the customers previously identified by the user.

In another case, a user (e.g., a marketing associate or a data analyst) accesses a user interface (e.g., the user interface of FIGS. 6 and 7) from his work computer (e.g., user terminal 114). The user selects an option to create a new marketing campaign based on a previous marketing campaign. Based on a user input, a previous marketing campaign template is selected from amongst previously executed marketing campaigns. A customer population is then derived from the previous marketing campaign. Next, the user inputs customer population parameters (e.g., exclusions) used to update the target customer population. On the backend, the customer information of the updated target customer population is stored in a database and validated. The resulting campaign configuration file is stored in a database (e.g., database 118) of the organization. Then, using the campaign file, the marketing campaign is sent, via email, to the updated target customer population.

1. A system comprising:
a transceiver;
a user terminal comprising a user interface;
an application;
one or more processors; and
at least one memory in communication with the one or more processors, the transceiver, the user terminal, and the application, and storing computer program code that, when executed by the one or more processors, is configured to cause the system to:
receive, at the user interface, a first request to create a marketing campaign with the application;
provide, at the user interface, an option to auto-populate one or more fields of the application;
receive, at the user interface, a selection of the option to auto-populate the one or more fields of the application;
retrieve, from a marketing campaign database, a first set of one or more fields based on previous customer population parameters;
auto-populate, by the user interface, the first set of the one or more fields in the application;
receive, at the user interface, data associated with an eligible customer population including new customer population parameters;
map, with the application, the first set and the new customer population parameters to vendor-specific variables;
output, with the transceiver, a second request for information about the eligible customer population using the vendor-specific variables to a customer information system storing customer information;
receive, at the transceiver, customer information associated with the eligible customer population from the customer information system;
identify, by the one or more processors, based at least in part on the new customer population parameters and the previous customer population parameters, a target population from the eligible customer population;
generate, by the one or more processors, a target population database including the customer information for the target population;
validate, by the one or more processors, the customer information stored in the target population database by:
comparing the customer information to the new customer population parameters and the previous customer population parameters to determine a partial match;
and
send, with the transceiver, the marketing campaign to a plurality of user devices associated with the target population.

2. The system of claim 1, wherein the new customer population parameters and the previous customer population parameters comprise at least one of brand-based clusters, product-based clusters, behavior clusters, propensity predictions, or collaborative filters.

3. The system of claim 1, wherein the computer program code is further configured to cause the system to:
receive, at the user interface, a selection of a previous marketing campaign;
extract, by the one or more processors, a campaign configuration template from the previous marketing campaign; and
derive, by the one or more processors, at least a portion of the target population from the campaign configuration template.

4. The system of claim 1, wherein the computer program code is further configured to:
cause the system to generate a workflow file and a quality control report, the quality control report including at least a campaign name, a campaign date, or a step required to execute the marketing campaign.

5. The system of claim 1, wherein the customer information comprises at least one of customer contact information, data representative of campaign responsiveness to marketing campaigns, or customer account information.

6. The system of claim 8, wherein
the first request further comprises data associated with one or more vendors for facilitating execution of the marketing campaign, and
the computer program code is further configured to output the campaign configuration in one or more formats, each of the one or more formats specific to at least one of the one or more vendors.

7. The system of claim 8, wherein the computer program code is further configured to cause the system to:
receive, at the user interface, a test request to test the campaign configuration, the test request comprising data associated with a test percentage of the target population and a control percentage of the target population;
send, with the transceiver, the marketing campaign to a first plurality of user devices associated with the test percentage of the target population and to a second plurality of user devices associated with the control percentage of the target population;
collect, by the one or more processors, first data regarding a first campaign responsiveness of the test percentage of the target population;
collect, by the one or more processors, second data regarding a second campaign responsiveness of the control percentage of the target population; and
automatically determine, by the one or more processors, the first campaign responsiveness based at least in part on a comparison of the first data and the second data.

8. The system of claim 1, wherein the computer program code is further configured to cause the system to:
generate, by the one or more processors, a first campaign file based at least in part on data received as part of the first request and the customer information for the target population; and
output, with the transceiver, the first campaign file comprising a campaign configuration to a campaign configuration database, wherein the campaign configuration database stores a plurality of campaign files.

9-22. (canceled)

23. The system of claim 8, wherein the computer program code is further configured to cause the system to:
output, with the transceiver, the customer information to a data segmentation device; and
receive, at the transceiver, a first segmented market population and a second segmented market population based at least in part on the customer information from the data segmentation device.

24. The system of claim 23, wherein the computer program code is further configured to cause the system to:
send, with the transceiver, the marketing campaign to a plurality of user devices, each user device associated with the first segmented market population or the second segmented market population.

25. The system of claim 23, wherein the first campaign file includes the first segmented market population and the second segmented market population.

26. (canceled)

27. The system of claim 8, wherein the computer program code is further configured to cause the system to:
access the campaign configuration database storing a plurality of campaign configuration files received from a plurality of previously-executed marketing campaigns.

28. The system of claim 27, wherein the computer program code is further configured to cause the system to:
identify, with the one or more processors, a first campaign configuration file based at least in part on the data in the first request, the first campaign configuration file comprising information about the target population.

29. The system of claim 3, wherein the computer program code is further configured to cause the system to:
update, by the one or more processors, the campaign configuration template based at least in part on the new customer population parameters, the update comprising an update to the target population.

30. The system of claim 29, wherein the computer program code is further configured to cause the system to:
send, with the transceiver, the marketing campaign to a plurality of user devices associated with the updated target population.

31. A system comprising:
a transceiver;
a user terminal comprising a user interface;
an application
one or more processors; and
at least one memory in communication with the one or more processors, the transceiver, the application, and the user terminal, and storing computer program code that, when executed by the one or more processors, is configured to cause the system to:
receive, at the user interface, a first request to create a marketing campaign with the application;
provide, at the user interface, an option to auto-populate one or more fields of the application;
receive, at the user interface, a selection of the option to auto-populate the one or more fields of the application;
retrieve, from a marketing campaign database, a first set of one or more fields based on previous customer population parameters;
auto-populate, by the user interface, the first set of the one or more fields in the application;
receive, at the user interface, data associated with an eligible customer population including new customer population parameters and a selection of a previous marketing campaign;
map, with the application, the first set and the new customer population parameters to vendor-specific variables;
output, with the transceiver, a second request seeking information about the eligible customer population using the vendor-specific variables to a customer information system storing customer information;
receive, at the transceiver, customer information associated with the eligible customer population from the customer information system;
extract, by the one or more processors, a campaign configuration template from the previous marketing campaign based on the first request;
derive, by the one or more processors, a first portion of a target population from the campaign configuration template;
identify, by the one or more processors, a second portion of the target population from the customer information based at least in part on the new customer population parameters and the previous customer populations parameters, the second portion of the target population selected from the eligible customer population;
generate, by the one or more processors, a target population database including the customer information for the target population;
validate the customer information stored in the target population database by:
comparing the customer information to the new customer population parameters and the previous customer population parameters to determine a partial match; and
send, with the transceiver, the marketing campaign to a plurality of user devices associated with the target population.

32. The system of claim 31, wherein the computer program code is further configured to:
generate, by the one or more processors, a campaign file based at least in part on data received as part of the first request and the customer information for the target population; and
output, with the transceiver, the campaign file comprising a campaign configuration to a campaign configuration database.

33. The system of claim 32, wherein extracting the campaign configuration template from the previous marketing campaign further comprises:
accessing the campaign configuration database storing a plurality of campaign configuration files received from a plurality of previously-executed marketing campaigns; and
identifying, by the one or more processors, a first campaign configuration file based at least in part on the data in the first request, the first campaign configuration file, and information about the target population.

34. The system of claim 32, wherein
the first request further comprises data associated with one or more vendors for facilitating execution of the marketing campaign; and
the computer program code is further configured to output the campaign configuration in one or more formats, each of the one or more formats specific to at least one of the one or more vendors.

35. The system of claim 32, wherein the computer program code is further configured to cause the system to:
receive, at the user interface, a test request to test the campaign configuration, the test request comprising data associated with a test percentage of the target population and a control percentage of the target population;
send, with the transceiver, the marketing campaign to a first plurality of user devices associated with the test percentage of the target population and to a second plurality of user devices associated with the control percentage of the target population;
collect, by the one or more processors, first data regarding a first campaign responsiveness of the test percentage of the target population;
collect, by the one or more processors, second data regarding a second campaign responsiveness of the control percentage of the target population; and
automatically determine, by the one or more processors, the first campaign responsiveness based at least in part on a comparison of the first data and the second data.

36. The system of claim 32, wherein the computer program code is further configured to cause the system to:
output, with the transceiver, the customer information to a data segmentation device; and
receive, at the transceiver, a first segmented market population and a second segmented market population based at least in part on the customer information from the data segmentation device.

37. The system of claim 36, wherein the computer program code is further configured to cause the system to:
send, with the transceiver, the marketing campaign to a plurality of user devices, each user device associated with the first segmented market population or the second segmented market population.

38. The system of claim 36, wherein the campaign file includes the first segmented market population and the second segmented market population.

39. The system of claim 31, wherein the computer program code is further configured to:
cause the system to generate a workflow file and a quality control report, the quality control report including at least a campaign name, a campaign date, or a step required to execute the marketing campaign.

40. The system of claim 31, wherein the customer information comprises at least one of customer contact information, data representative of campaign responsiveness to marketing campaigns, or customer account information.
